(19) United States
(12) Patent Application Publication
(10) Pub. No.: US 2004/0238045 A1
(43) Pub. Date: Dec. 2, 2004

(54) Gear Driven Damper with Blades for Sensing Pressure Differential

(75) Inventor: Robert Van Becelaere, Lake Lotawana, OH (US)

Correspondence Address: CALFEE HALTER & GRISWOLD, LLP, 800 SUPERIOR AVENUE, SUITE 1400, CLEVELAND, OH, 44114, US

(73) Assignee: RUSKIN COMPANY, Grandview, MO (US)

(21) Appl. No.: 10/250,068

(22) Filed: Jun. 2, 2003

(51) Int. Cl. F16K 37/00

(52) U.S. Cl. 137/557

(57) ABSTRACT

A fluid flow damper for use within a duct includes a first blade having a wing section and a base section. The damper also includes a second blade having a wing section and a base section engaged with the base section of said first blade. A first passage is defined by the base section of the first blade with one or more ports providing fluid communication between the passage and a fluid upstream of the damper within the duct in order to measure the velocity pressure plus static pressure within the duct. Additionally, a second passage is defined by the base section of the second blade with one or more ports providing fluid communication between the passage and a fluid downstream of the damper within the duct in order to measure the static pressure within the duct.

### BACKGROUND OF INVENTION

This invention relates to dampers for regulating fluid flow and more particularly to a damper blade construction which may be used for sensing the velocity pressure and static pressure of fluid flowing across the damper.

Dampers are employed for controlling flow of gasses in a variety of situations. They are conventionally used to control the amount of fresh air which is admitted into buildings. Energy conservation purposes generally dictate that the amount of fresh air admitted to a building be kept to a minimum. On the other hand, it is necessary that a certain minimum flow of fresh air be maintained to prevent build up of pollutants in the building. The necessity for maintaining a balance between meeting fresh air requirements and conserving energy makes control of air flow very important.

Conventionally, the air flow on each side of a damper is sensed by a pitot tube sensor or by other suitable sensing devices installed in the air stream. Sensors have recently been developed which are part of the damper blades or vanes. The pressure upstream of the damper consists of a combination of the velocity pressure (Vp) plus the static pressure (Sp). The measured pressure immediately downstream of the damper consists essentially of only static pressure if the fluid is admitted to a sensing device which faces downstream to eliminate the effect of the velocity of the stream on the measurement. The difference between these pressures is the velocity pressure. This figure, for all practical purposes with which we are here concerned, is directly proportional to the flow across the damper. Thus, Vp can be used for determining how the damper should be adjusted to provide a predetermined flow through the damper.

A problem encountered in damper regulation with available technology has been the necessity for obtaining pressure readings for use in adjusting the dampers used in controlling the flow. U.S. Pat. No. 5,379,792 to Van Becelaere discloses a damper wherein one or more of the damper blades also includes fluid intake openings and separate chambers used for sensing pressure. The blade of the ″792 patent includes three hollow chambers of somewhat wider construction compared to traditional, non-sensing, thin damper blades.

It is a primary object of this invention to provide a simple damper which includes the benefit of on-blade sensors, but which includes the benefits provided by flat blades. Further, many existing dampers use a group of blades. A drawback to most of these designs is that each blade must be individually actuated via a bracket or linkage mechanism. This type of mechanism may be difficult to assemble and noisy in operation. Additionally the bracket or linkage is attached at only one point on each blade or blade axle typically. Thus, a failure at this point results in a blade which can not be controlled. It is another important object of this invention to provide a dual blade damper in a butterfly type configuration in which both blades include sensors and may be controlled with a single actuator.

### SUMMARY OF INVENTION

One embodiment of the invention provides a fluid flow damper for use within a duct, the damper including a first blade having a wing section and a base section. The damper also includes a second blade having a wing section and a base section engaged with the base section of the first blade. A first passage is defined by the base section of the first blade with one or more ports providing fluid communication between this passage and a fluid upstream of the damper within the duct in order to measure the velocity pressure plus static pressure within the duct. Also a second passage is defined by the base section of the second blade with one or more ports providing fluid communication between this passage and a fluid downstream of the damper within the duct in order to measure the static pressure within the duct. The damper also includes an actuator for rotating the first blade whereby the rotation of the base section of the first blade causes the second blade to rotate via the engaged base section of the second blade.

In another embodiment of the invention a fluid flow damper for use within a duct is provided including a first blade having a wing section and a base section, the base section including a geared portion extending along the length of the first blade, a second blade having a wing section and a base section, the base section including a geared portion extending along the length of the second blade and wherein the geared portion of the second blade is engaged with the geared portion of the first blade. The damper also includes an actuator for rotating the first blade whereby the rotation of the base section of the first blade causes the second blade to rotate via the engaged geared portion of the second blade.

The damper of the present invention provides a damper having pressure sensing capabilities also, with generally thin flat blades which minimizes disturbances in the stream of flow. The damper of the present invention also provides a linkage free system where all damper blades can be controlled by a single actuator. The damper of the present invention also provides a butterfly type design which is easily adaptable for use in round ducts.

### BRIEF DESCRIPTION OF DRAWINGS

FIG. 1 is an exterior side view of a duct including the damper of the present invention;

FIG. 2 is a front view of a duct including the damper of the present invention;

FIG. 3 is a cutaway side view of a duct including the damper of the present invention in a fully open position;

FIG. 4 is a cutaway side view of a duct including the damper of the present invention in a fully closed position;

FIG. 5 is a detailed view of a portion of the blades of the damper of the present invention;

FIG. 6 is a detailed view of a portion of the blades of the damper of the present invention showing a variation in port location;

FIG. 7 is a detailed view of a portion of the blades of the damper of the present invention showing yet another variation in port location;

FIG. 8 is a front view of a single blade of the damper of the present invention;

FIG. 9 is a front view of a duct including an alternate embodiment of a damper of the present invention; and

FIG. 10 is a front view of a single blade of an alternate embodiment of a damper of the present invention.

### DETAILED DESCRIPTION

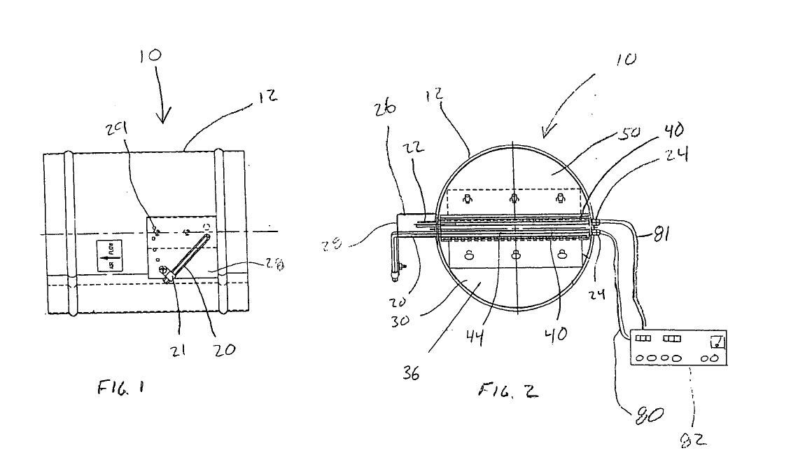

FIG. 2 shows a preferred damper of the present invention, indicated generally at 10, within a circular duct. The blades of the damper 10 may be manufactured in any desired shape for the damper 10 to be placed within a similarly shaped duct. Fluid within the duct 12 flows in a direction indicated by the arrow in FIG. 1 and, thus, defines an upstream side of the damper 10 on one side of the blades and a downstream side on the alternate side of the blades.

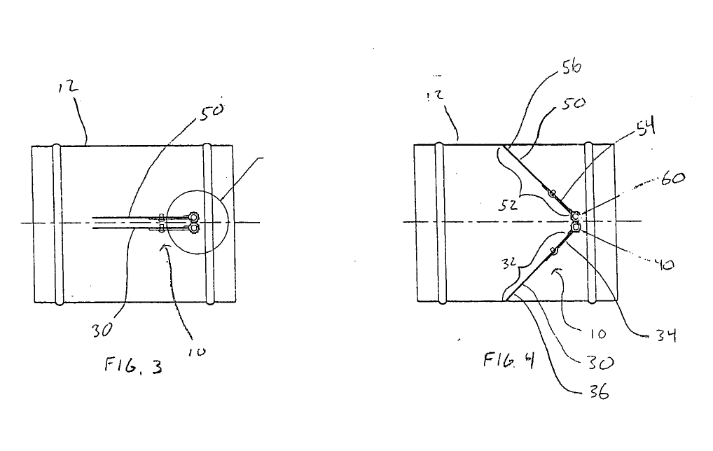

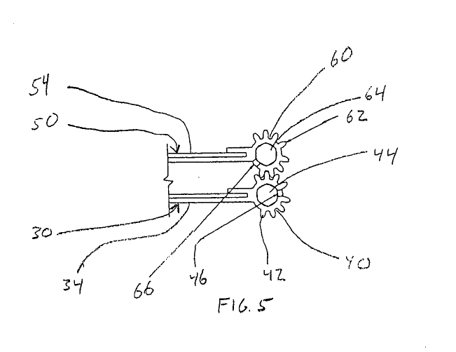

Referring back to FIG. 2, in the embodiment of the damper 10 chosen for illustration damper 10 is provided with two blades 30 and 50 shaped at their periphery to fit within a round duct 12 such that the duct 12 may be substantially blocked when the damper 10 is in a fully closed position. The blades 30 and 50 open and close in a butterfly fashion. FIG. 3 shows the blades 30 and 50 in a fully open position and FIG. 4, a fully closed position. The blades 30 and 50 may be positioned at any intermediate position to adjust the stream of flow through the duct 12 as desired. Referring to FIG. 2, the blades 30 and 50 are supported on axle members, one of which when rotated acts as an actuator 20 as described in more detail below.

Construction of the blades 30 and 50 is illustrated in FIGS. 4, 5 and 8. Each blade comprises a wing section 32 and 52 and a base section 40 and 60. Referring now only to wing section 32 of blade 30, an arm section 34 and blade attachment 36 comprise the wing section 32. The arm section 34 is a flat fin of rectangular shape, although any shape may be used. The arm section 34 may be formed of polymer or aluminum, or aluminum alloy material. In a preferred embodiment the arm section 34 has a thickness of 100millimeters (20 gauge). The arm section 34 may be formed integrally with the base section 40 of the blade 32. The arm section 34 and base section 40 may be formed together via a molding or extrusion process. The arm section 34 is rotated by the base section 40 of the blade 30 and acts in combination with the blade attachment 36 to partially or substantially seal the cross section of the duct 12 to prevent fluid flow. The arm section 34 may be attached to blade attachment 36 using screws, rivets or any other type of fastener. The arm section 34 may be sized generally to fit a certain sized duct 12. To provide for flexibility in manufacturing and purchase by a consumer, a uniformly sized arm section 34 may be used with different sized and/or shaped blade attachments 36, such that small variations in duct 12 size or shape do not require newly sized arm sections 34, but only newly sized blade attachments 36.

The blade attachment 36 at its periphery is shaped similarly to the duct 12 within which the damper 10 is placed. As shown in FIG. 2, this may be a round shape. The blade attachment 36 is attached to the arm section 34 of the blade 30. In another embodiment of the invention, the arm section 34 and blade attachment 36 may be formed as a single piece. The blade attachment 36, in combination with the arm section 34 functions to prevent the flow of fluid in the duct 12. The blade attachment 36 is configured to come very close to or gently abut the interior surface of the duct 12 when the damper 10 is in a fully closed position. A gap may be left around the blades however to avoid undue back pressure in the system when the damper 10 is in a fully closed position. The blade attachment 36 may be formed from aluminum, aluminum alloys or polymer. In a preferred embodiment, the blade attachment 36 is flat having a thickness of 100 millimeters (20 gauge). The degree in which the blade attachment 36 overlaps the arm section 34 as shown in FIG. 4 may be determined by the needs of stability. In a preferred embodiment, the overlapping portions have a combined thickness which does not exceed 200 millimeters.

Blade 50 has a wing section 52 of similar construction to the wing section 32 described above, including an arm section 54 and blade attachment 56.

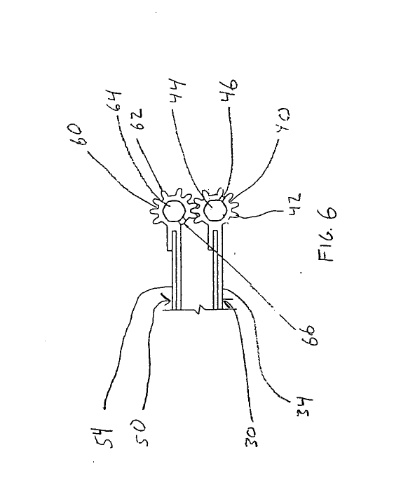

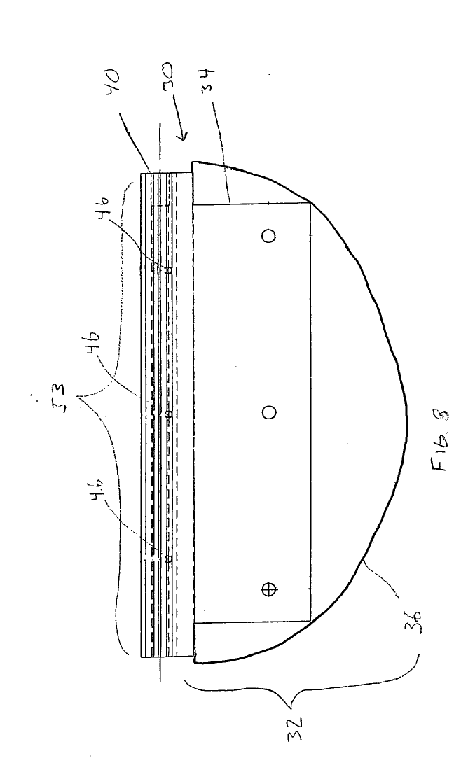

Each blade 30 and 50 also includes a base section 40 and 60. Referring to FIG. 5 the base section 40 of blade 30 includes a plurality of gear teeth 42 on its exterior surface. The teeth 42 in combination as shown comprise a spur gear. Other gear types, such as helical gears may also be used. The gear teeth 42 engage with the gear teeth 62 from an adjacent blade 50 and as one of the blades is rotated, the gear teeth transfer this motion to the adjoining blade. Other means of engaging the adjacent base sections.40 and 60 may also be used including belts, chains or frictional engaging surfaces. The base section 40 of the blade 30 may be formed from the same material as the wing section 32 of the blade 30. Alternatively, a base section 40 of an alternative material to the wing section may be attached to the wing section 32. Also, a geared sleeve (not shown) may be placed over a toothless base section. Referring to FIG. 8, the gear tooth 42 formations extend for an axial length 53 of the blade 30 and is considered the geared portion of the blade 30. A geared portion is shown extending the full length of the blade, but may consist of any axial length of the base portion of a blade in excess of 1.25 centimeters (½ inch). As shown in FIG. 2, the base section 40 is oriented at an end of the blade 30 near the center of the duct and adjacent the base section 60 of the opposite blade 50. As a result, a centrally located actuator 20 is able to move both blades 30 and 50 between a fully open and fully closed position.

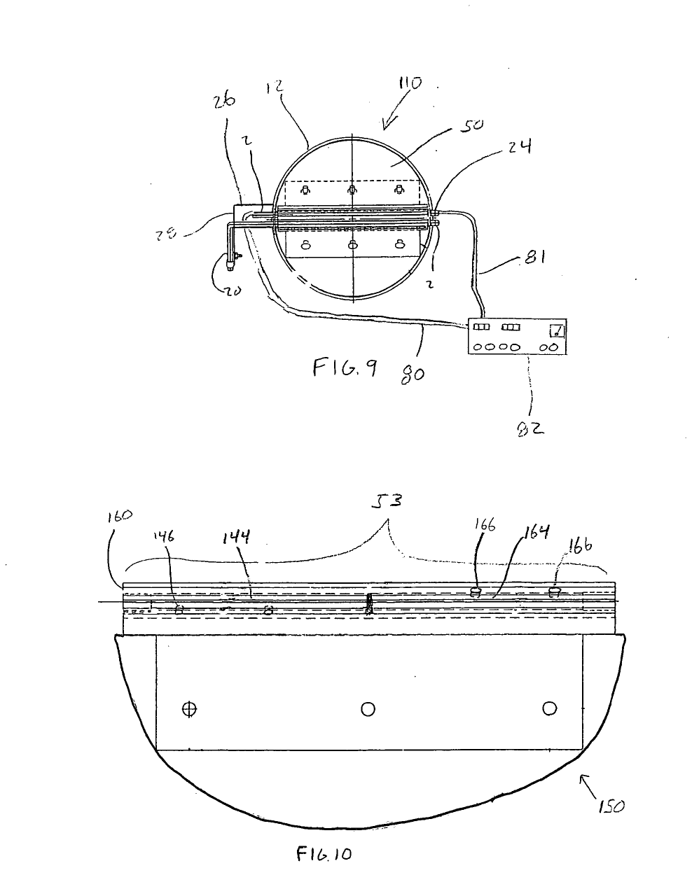

Referring back to FIG. 5, the base section 40 and 60 of each blade 30 and 50 defines a passage 44 and 64. The passages 44 and 64 are shown having a generally hexagonal cross section, but may have any shape cross section including round or rectangular. The passages 44 and 64 may be oriented in the center of the cross-section of the base section 40 and 60. The passages 44 and 64 extend generally in excess of one half of the length of the blade 30 and 50 but may be any length. The passages 44 and 64 function as part of a pressure sensing system with ports 46 and 66 in the base section 40 and 60, transfer tubes 80 and 81 and a pressure measuring device 82. The passages 44 and 64 are open to the duct 12 via ports 46 and 66 as described below. The passages 44 and 64 also provide a point of attachment for pressure sensing transfer tubes 80 and 81 via an axle member. In a preferred embodiment, a single passage 44 and 64 has a diameter of 635 millimeters (¼ inch). In an alternate embodiment of the invention 110 shown in FIGS. 9 and 10 both passages 144 and 164 are part of a single blade 150. The passages 144 and 164 extend for less than one half of the length of the base section 160 of blade 150. The passages 144 and 164 are isolated from each other.

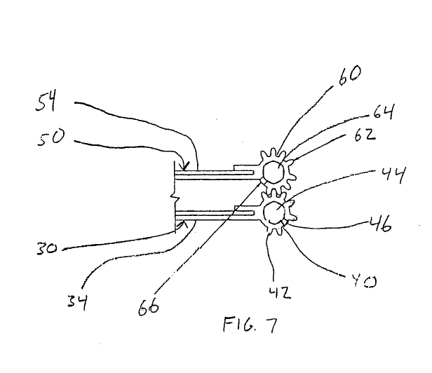

Referring back to FIG. 5, the base section 40 and 60 of each blade 30 and 50 defines one or more ports 46 and 66. The ports 46 and 66 provide fluid communication between the fluid within the duct 12 and the passage 46 and 66 within the base section 40 and 60. The ports 46 and 66 are drilled into the base section 40 and 60 and in a preferred embodiment have a diameter of 159 millimeters (1/16 inch). The ports 46 and 66 are oriented differently on blades 30 and 50. As seen in FIG. 5 the ports 46 in blade 30 are formed into the upstream side of the base section 40. Oppositely, the ports 66 in blade 50 are formed into the downstream side of the base section 60. The ports 46 and 66 may be offset from a position directly in line with a downstream direction (see port 46 in FIG. 6 and port 66 in FIGS. 5-7). The ports may be offset up to 45 degrees in either direction from an in line position. Part of the gear tooth 42 may be milled away to provide a location for a port 46 as shown in FIG. 7. The ports 46 are spaced along the length of the base section 40 of the blade 30 as shown in FIG. 8. In a preferred embodiment of the invention a damper for use within a 15.25 cm. (6 inch) diameter duct includes 2 ports on each blade. In a damper for use within a 20.3, 25.4, 30.5 cm. (8,10 or 12 inch) diameter duct 3 ports are included on each blade. The ports 46 oriented in a generally upstream direction are used to measure the velocity pressure plus static pressure of fluid within the duct 12. The parts 66 oriented in a generally downstream direction are used to measure the static pressure of fluid within the duct 12. In the alternate embodiment of the invention 110 shown in FIGS. 9 and 10 ports 146 and 166 are oriented in different directions and are part of a common blade 150, providing access to different, isolated passages 144 and 164. The spacing of these ports varies from that in the first embodiment.

Referring to FIG. 2, each blade 30 and 50 is supported within a duct 12 by axle members. The axle members may be a stub axle 22, extended axle 20 or dual purpose fitting 24 as described below. As shown an extended axle 20 supports blade 30 as well as actuating movement of the damper 20. Extended axle 20 includes one end inserted into the central passage 44 of blade 30. The shaft of extended axle 20 may have a cross sectional shape similar to the shape of the central passage 44 of the blade 30 it is affixed to. The extended axle 20 seals the central passage 44 by means of an o-ring around the extended axle shaft in a sealing relationship between the shaft and the wall of the base section 40. It is understood that other types of actuators known in the art may be used to rotate the first blade 30, including motors with shafts, belt and pulley systems, etc. The axle members would be shaped appropriately to interact with these different types of actuators.

A dual purpose fitting 24 supports the opposite end of blade 30 within a duct 12. The dual purpose fitting 24 may be a compact one-piece push on barbed fitting which supports the blade 30 as well as provides a connection for a transfer tube 80. The dual purpose fitting 24 is open to the central passage 44 of blade 30.

Transfer tube 80 connected to a second open end of the dual purpose fitting 24 which allows the sampling of the pressure within the central passage 44 by the pressure measuring device 82.

A stub axle 22 supports the end of blade 50 adjacent to the extended axle 20 supporting blade 30. Stub axle 22 has a cross sectional shape similar to the shape of the central passage 64 of blade 50. An o-ring around the extended axle shaft in may be in a sealing relationship between the shaft and the wall of the base section.

A dual purpose fitting 24 supports the opposite end of blade 50 within a duct 12. The dual purpose fitting 24 is open to the central passage 64 of blade 50. Transfer tube 81 connected to a second open end of the dual purpose fitting 24 allows the sampling of the pressure within the central passage 64. The axle members may be placed in any configuration to support the blades. (i.e. dual purpose fittings on opposite sides, etc.) As shown in FIG. 9, in an embodiment of the invention with two isolated passages 144 and 164 within a single blade 150, dual purpose fittings 24 may be used to support both ends of a blade 150 within a duct 12.

Referring to FIGS. 2 and 9, a positioning bracket 26 may be attached to the duct 12 exterior. Both the extended axle 20 and stub axle 22 or dual purpose fitting 24 may protrude through apertures defined by the positioning bracket 26. The positioning bracket 26 may be formed having a channel shaped cross section with a face abutting the duct 12 and a generally parallel distal face 28 used for damper 10 positioning. The extended axle 20 may include a 90 degree bend at a position offset from the duct 12 proximal with the distal face 28 of the positioning bracket 26. The distal portion of the extended axle 20, thus, is parallel to and when rotated, sweeps across the distal face 28 of the positioning bracket 26. Referring to FIG. 1, a plurality of apertures 29 are defined by the positioning bracket 26 which are radially aligned with a point on the extended axle 20. A small clamp and nut assembly 21 may be attached to the extended axle 20 and affixed at selected positions upon the positioning bracket 26. These positions correspond to desired degrees of opening of the damper 10.

Referring to FIG. 1, 2, 3 and 5, fluid flows in a right to left direction through the duct 12 when in operation. Extended axle 20 may be moved to change the position of the damper 10. At different desired positions, the damper blades 30 and 50 may be held in place using the clamp and nut assembly 21 in combination with the. apertures 29 within the positioning bracket 26. While fluid is flowing through the duct 12 pressure measurements may be taken using the damper blades 30 and 50, the transfer tubes 80 and 81 and the pressure measuring device 82. The ports 46 within the base section 40 of blade 30 point generally in an upstream direction and may sample the fluid pressure which is representative of the velocity pressure plus the static pressure within the duct 12. Pressure readings are made by the pressure measuring device 82 from the ports 46 via the passage 44 and transfer tube 80. The ports 66 within the base section 60 of blade 50 point generally in a downstream direction and may sample the fluid pressure which is representative of the static pressure within the duct 12. Pressure readings are made by the pressure measuring device 82 from the ports 66 via the passage 64 and transfer tube 81. The difference between these measurements is representative of the velocity pressure within the duct 12.

Although the invention has been shown and described with reference to certain preferred and alternate embodiments, the invention is not limited to these specific embodiments. Minor variations and insubstantial differences in the various combinations of materials and methods of application may occur to those of ordinary skill in the art while remaining within the scope of the invention as claimed and equivalents. Use of the term “or” herein is the inclusive, and not the exclusive use.

1. A fluid flow damper for use within a duct comprising:
a first blade having a wing section and a base section;
a second blade having a wing section and a base section engaged with said base section of said first blade;
a first passage defined by said base section of said first blade with one or more ports providing fluid communication between said passage and a fluid upstream of the damper within the duct in order to measure the velocity pressure plus static pressure within the duct;
a second passage defined by said base section of said second blade with one or more ports providing fluid communication between said passage and a fluid downstream of the damper within the duct in order to measure the static pressure within the duct;
an actuator for rotating said first blade whereby the rotation of the base section of said first blade causes said second blade to rotate via said engaged base section of said second blade.

2. The fluid flow damper of claim 1 wherein said wing section of said first blade includes an arm section and a blade attachment.

3. The fluid flow damper of claim 2 wherein said arm section is integrally formed with said base section.

4. The fluid flow damper of claim 2 wherein said wing section of said first blade and said wing section of said second blade have a shape at their periphery which is generally equivalent to the interior shape of the duct.

5. The fluid flow damper of claim 4 wherein said wing section of said first blade and said wing section of said second blade at their periphery are generally equivalent to the interior shape of a round duct.

6. The fluid flow damper of claim 1 wherein said first passage defined by said base section of said first blade is centrally located within said base section.

7. The fluid flow damper of claim 1 wherein said first passage defined by said base section of said first blade extends greater than one half of the length of the first blade.

8. The fluid flow damper of claim 1 wherein said base section of said first blade includes a geared portion which engages with the base section of the second blade.

9. The fluid flow damper of claim 8 wherein said geared portion of said base section of said first blade is integrally formed with said base section of said first blade.

10. The fluid flow damper of claim 8 wherein said base section of said second blade includes a geared portion which engages with the geared portion of said first blade.

11. The fluid flow damper of claim 1 wherein said wing section of said first blade has a thickness which does not exceed about 200 millimeters.

12. The fluid flow damper of claim 1 wherein said actuator is an extended axle supporting one end of said first blade.

13. The fluid flow damper of claim 12 wherein the opposite end of said first blade is supported by a dual purpose fitting which provides access from said first passage to a transfer tube for pressure sampling.

14. The fluid flow damper of claim 13 wherein said second blade is supported at one end by a stub axle and at an opposite end by a dual purpose fitting which provides access from said second passage to a second transfer tube for pressure sampling.

15. A fluid flow damper for use within a duct comprising:
a first blade having a wing section and a base section, said base section including a geared portion extending along at least part of the axial length of the first blade;
a second blade having a wing section and a base section, said base section including a geared portion extending along at least part of the axial length of said second blade and wherein said geared portion of said second blade is engaged with said geared portion of said first blade;
an actuator for rotating said first blade whereby the rotation of said base section of said first blade causes said second blade to rotate via said engaged geared portion of said second blade.

16. The fluid flow damper of claim 15 wherein said geared portions of said first and second blades extends at least 1.25 centimeters along said length of said blades.

17. The fluid flow damper of claim 15 wherein said wing section of said first blade includes an arm section and a blade attachment.

18. The fluid flow damper of claim 17 wherein said arm section is integrally formed with said base section.

19. The fluid flow damper of claim 15 wherein said wing section of said first blade and said wing section of said second blade have a shape at their periphery which is generally equivalent to the interior shape of the duct.

20. A fluid flow damper for use within a duct comprising:
a first blade having a wing section and a base section;
a second blade having a wing section and a base section engaged with said base section of said first blade;
a first passage defined by said base section of said first blade with one or more ports providing fluid communication between said passage and a fluid upstream of the damper within the duct in order to measure the velocity pressure plus static pressure within the duct;
a second passage defined by said base section of said first blade, said second passage being isolated from said first passage and including one or more ports providing fluid communication between said passage and a fluid downstream of the damper within the duct in order to measure the static pressure within the duct;
an actuator for rotating said first blade whereby the rotation of the base section of said first blade causes said second blade to rotate via said engaged base section of said second blade.
